(19) United States
(12) Patent Application Publication
(10) Pub. No.: US 2015/0135296 A1
(43) Pub. Date: May 14, 2015

(54) CATALOG DRIVEN ORDER MANAGEMENT FOR RULE DEFINITION

(71) Applicant: International Business Machines Corporation, Armonk, NY (US)

(72) Inventors: Stanley P. Cason, Johnson City, NY (US); Gautam Majumdar, Wappingers Falls, NY (US); Prabhat Sharma, Morrisville, NC (US)

(73) Assignee: International Business Machines Corporation, Armonk, NY (US)

(21) Appl. No.: 14/079,880

(22) Filed: Nov. 14, 2013

(51) Int. Cl. H04L 29/06

(52) U.S. Cl. CPC H04L 63/0815
USPC 726/8

(57) ABSTRACT

Centralized single sign-on service for entitlement for multiple different application interface objects to relational database objects is provided as a function of a set of relational extensible mark-up language links. Roles are mapped to a unique user identification by a first extensible mark-up language link. A permission value within a second extensible mark-up language link that specifies a type of access to a unique data object identification is linked to the roles mapped in the first link. An object type and an object name within another extensible mark-up language link are linked to the determined permission value and to the unique data object identification. Access to a data object within a database by different external applications is enabled pursuant to the determined permission value as a function of the data object having the unique data object identification, the first and the second external applications using different application formats.

### FIELD OF THE INVENTION

The present invention relates to automated and programmable mechanisms for application-independent centralized, secured sign-on entitlement or authorization services.

### BACKGROUND

Centralized, secured sign-on entitlement or authorization services (SSO) are used to authenticate users to grant access to networked resources. In some examples deployed for public access (for example, through internet entry points into networked resources) Security Assertion Markup Language (SAML) SSO is used is to authenticate a user to an Identity Provider (IdP). Upon successful authentication of the user, the IdP sends a SAML security token to a service provider (SP) in order to authenticate the user to the SP and thereby enable access to the network resource by the user via the SP. This must generally be repeated, or alternative security processes and routines executed, with respect to each different SP used by the user for access to a networked resource.

SSO's may provide centralized Identity Provider (IdP) authentication services, wherein a single IdP provides a single sign-on for user access to several, different service providers (SP's) via a single verification method. Such centralized IdP's may store multiple combinations of different, unique user identification (ID's) and passwords, user attributes and preferences (language, payment information, etc.), for use in directly interfacing with each of various, different external applications, to thereby gain access to different networked resources on behalf of the user via each of the different external applications.

### BRIEF SUMMARY

In one aspect of the present invention, a method provides for a centralized single sign-on service for entitlement for multiple different application interface objects to relational database objects as a function of a set of relational extensible mark-up language links. The method includes determining one or more roles that are mapped to a unique user identification by a first extensible mark-up language link, in response to a secure, single sign-on validation of the unique user identification. A permission value within a second extensible mark-up language link is linked to the role(s) provided in the first extensible mark-up language link, wherein the permission value specifies a type of access to a unique data object identification. An object type and an object name within a third extensible mark-up language link are linked to the determined permission value and to the unique data object identification. Accordingly, access to a data object within a database by different external applications is enabled to pursuant to the determined permission value as a function of the data object having the unique data object identification, wherein the first and the second external applications use different application formats.

In another aspect, a system has a processor, computer readable memory and a computer-readable storage medium with program instructions, wherein the processor, when executing the stored program instructions, determines that one or more roles are mapped to a unique user identification by a first extensible mark-up language link, in response to a secure, single sign-on validation of the unique user identification. A permission value within a second extensible mark-up language link is linked to the role(s) provided in the first extensible mark-up language link, wherein the permission value specifies a type of access to a unique data object identification. An object type and an object name within a third extensible mark-up language link are linked to the determined permission value and to the unique data object identification. Accordingly, access to a data object within a database by different external applications is enabled pursuant to the determined permission value as a function of the data object having the unique data object identification, wherein the first and the second external applications use different application formats.

In another aspect, a computer program product has a computer-readable storage medium with computer readable program code embodied therewith, the computer readable program code including instructions that, when executed by a processor, cause the processor to determine that one or more roles are mapped to a unique user identification by a first extensible mark-up language link, in response to a secure, single sign-on validation of the unique user identification. A permission value within a second extensible mark-up language link is linked to the role(s) provided in the first extensible mark-up language link, wherein the permission value specifies a type of access to a unique data object identification. An object type and an object name within a third extensible mark-up language link are linked to the determined permission value and to the unique data object identification. Accordingly, access to a data object within a database by different external applications is enabled pursuant to the determined permission value as a function of the data object having the unique data object identification, wherein the first and the second external applications use different application formats.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a flow chart illustration of aspects according to the present invention for centralized SSO entitlement service for multiple different applications to relational database objects as a function of a set of relational XMLs.

FIG. 2 is a tabular illustration of relational XMLs according to the present invention.

FIG. 3 is a tabular illustration of relational XMLs according to the present invention.

FIG. 4 is a tabular illustration of a relational XML according to the present invention.

FIG. 5 is a block diagram illustration of a set of relational XMLs according to the present invention.

FIG. 6 is a block diagram of a computer system implementation of an aspect of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium excludes transitory, propagation or carrier wave signals or subject matter and includes an electronic, magnetic, optical or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that does not propagate but can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic or optical forms or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions, which execute on the computer or other programmable apparatus, provide processes for implementing the functions/acts specified in the flowchart and/or block diagram block or blocks.

However, differences in platforms and programming language between the various external applications add complexity and difficulties in effecting SSO for access to multiple SP's. For example, a first SP may require that a service be called within its application framework in a first programming language format, a second SP may require that a service be called within its application framework in a different, second programming language format, and a third may enable a service to be called outside of its application framework.

Aspects of the present invention provide for platform independent and programming language independent SSO via the use of extensible mark-up language (XML) security links. Rather than creating a table for managing pluralities of different user ID, password and application formats, and choosing the correct data and format to use with each different application, aspects create a relational database structure from a plurality of XML links. The XML links define relationships between the XML to define application-independent object handling structures. One centralized SSO interface uses the relational XML's to define entitlement or authorization services for data objects that is universal and independent of the different formats and requirements of the various applications authorized by the SSO.

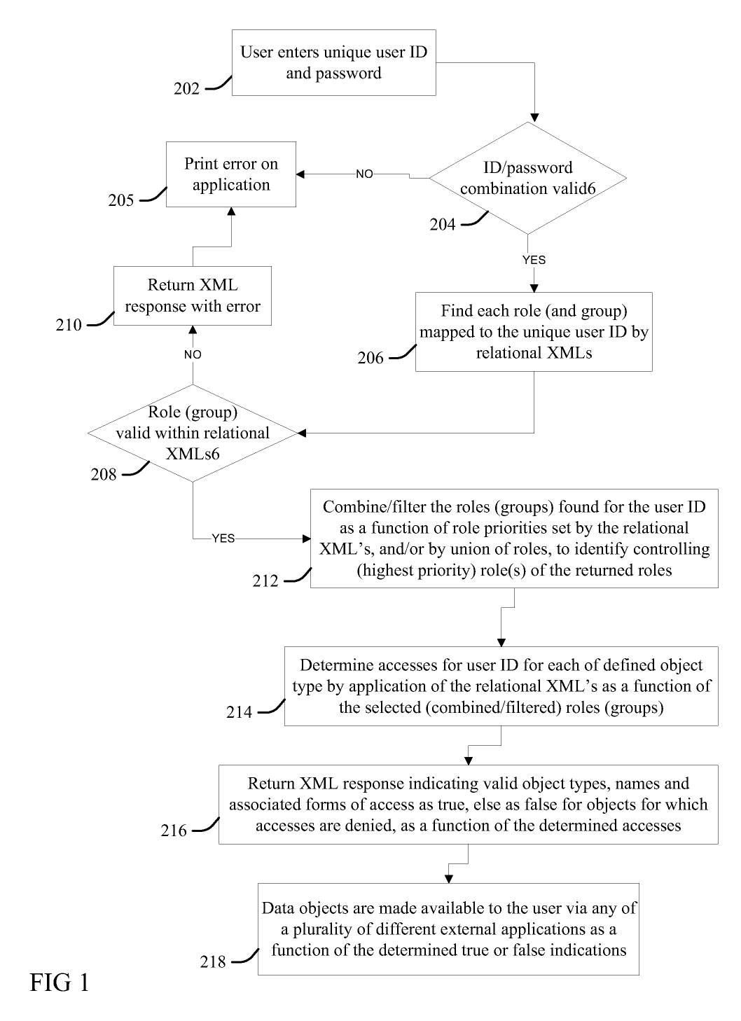

FIG. 1 is a flow chart illustration of an implementation of an aspect of the present invention that provides a centralized SSO entitlement service for multiple different application interface objects to relational database objects as a function of a set of relational XMLs. Examples of objects accessible by different external applications via the centralized SSO include database tables, fields, datasets, and user interface objects including text boxes, pages, menus, report columns, submenus, labels, etc. At 202 a user enters a unique user ID and password. If the combination is not valid at 204, then an error message is returned at 205 (for example, generating a print error on an application), wherein the user may try again, etc. If the user ID/password combination is validated at 204, then at 206 the process finds each role mapped to the unique user ID by the relational XMLs. In some aspects, the relational XMLs are also used to identify any user subset groups associated with the mapped roles.

At 208 the role(s) (and group identification(s)) returned for the user ID are validated, for example by checking against a master list for the relational XMLs to verify that a returned role combination, or a role and subgroup combination, is stored in the master list as a possible (allowable) combination. If the returned roles, (or groups or combinations thereof) are not validated at 208, that is the returned combination(s) are not stored in the master list, then an XML response is returned with an error indication at 210, and the error message is returned at 205.

If validated at 208, then at 212 the role IDs and groups identified for the user ID are combined or filtered by application of the relational XML's, in some aspects as a function of role priorities, to identify one or more or controlling (highest priority) roles of the returned roles. In some aspects, multiple returned roles are prioritized, and the highest priority role is selected or filtered out of all of the returned roles. Roles are also selected by unions of roles, either just those having a common highest priority, or of all rules if no priorities are defined or applicable.

At 214 accesses for this user ID for each of defined object types are determined by application of the relational XML's as a function of the selected (combined or filtered) roles (and in some aspects, of groups) identified at 212. Any conflicts in accesses granted to the same objects or related objects via different accesses granted by multiple applicable rules within the rules selected at 212 are resolved by rule priorities or unions of rule, including as a function of group or parent relationships.

At 216 an XML response is returned indicating all valid object types, names and associated forms of access (read, write, create, etc.) as true for the user ID as defined by the accesses determined at 214, else as false for object accesses that are denied by application of the determined accesses indicated by the selected rules. It is noted that returning the XML response at 216 does not check all objects, only those that are controlled by the relational XMLs via specified attributes. Some data objects within a relational database and user interface objects are independent or otherwise not controlled by the relational XMLs, as they may have no association to the attributes of interest. The data objects are then made available to the user at 218 via any of a plurality of different external applications in communication with the SSO, as a function of the true or false indications determined for each of the data objects/access operations at 216.

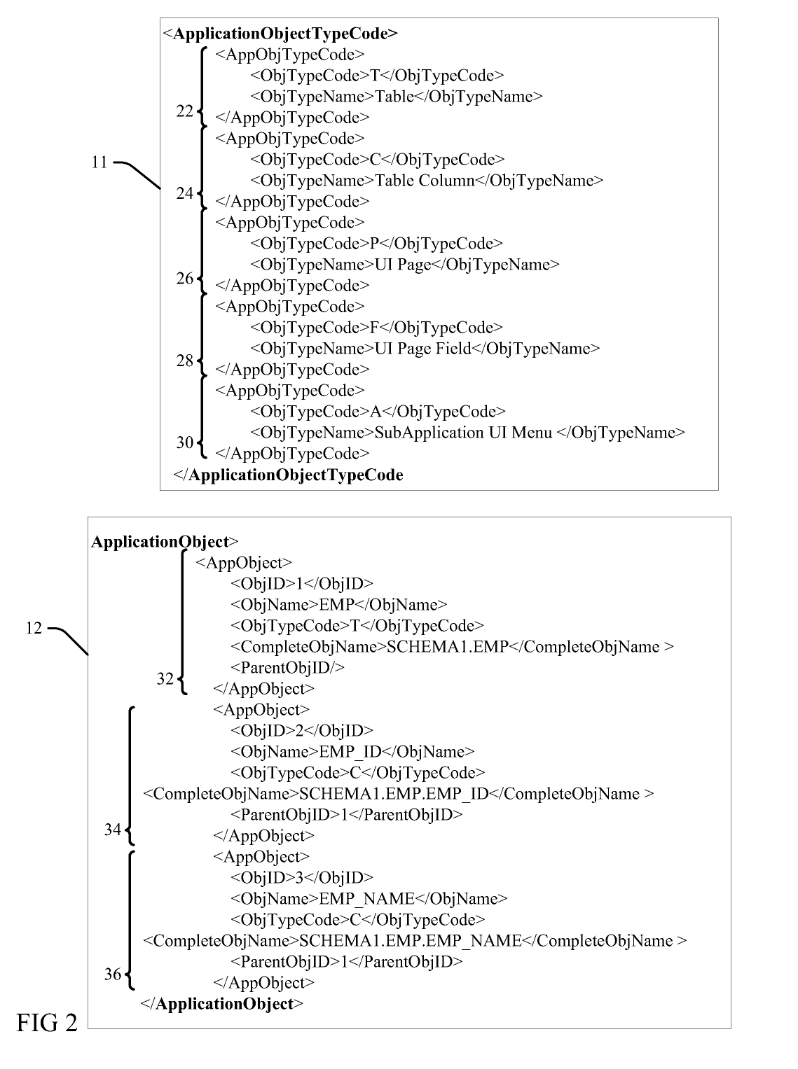

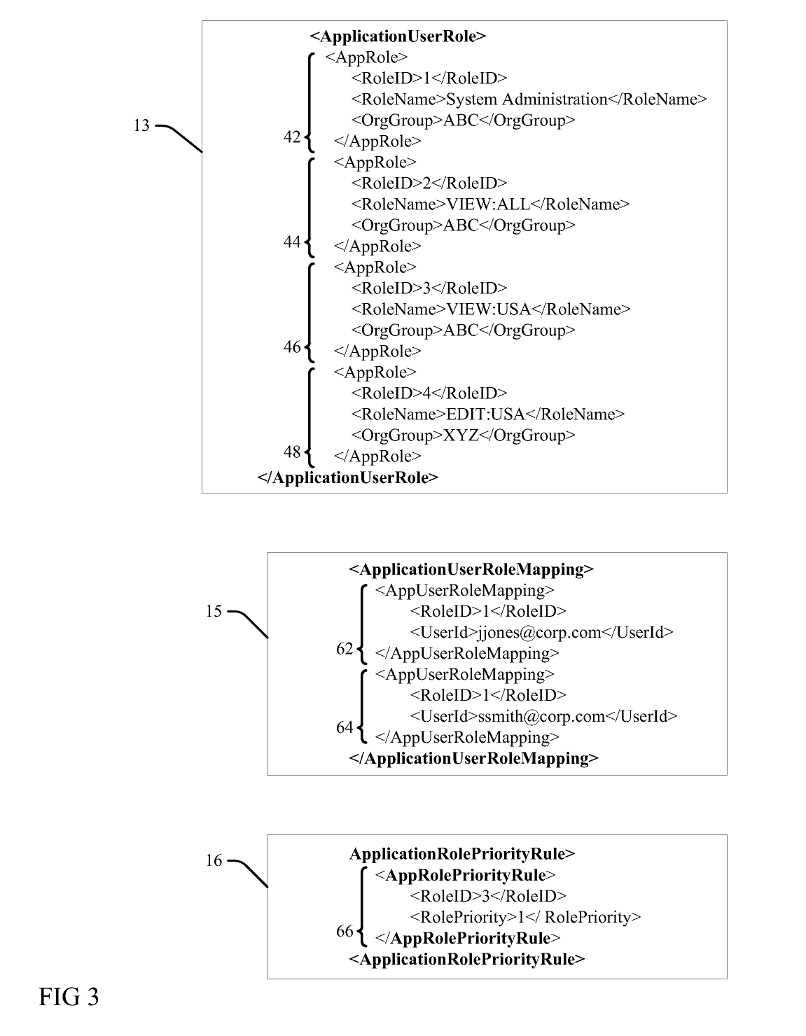

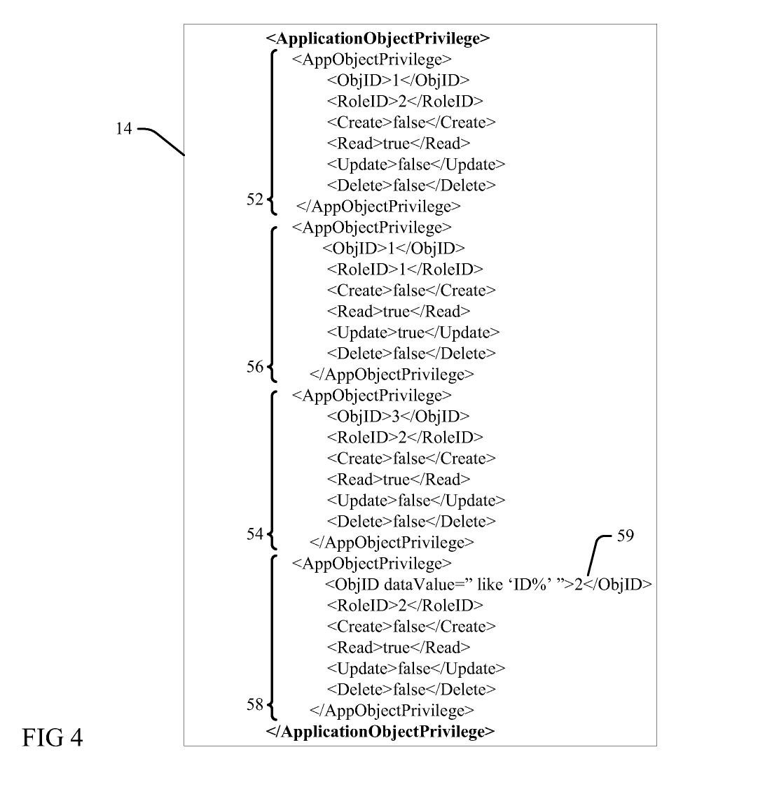

FIGS. 2 through 4 illustrate one example of a set of the relational XMLs that together are useful to control user access to relational database data objects for user interface (UI) and/or non-UI applications: an ApplicationObjectTypeCode.xml 11, an ApplicationObject.xml 12, an ApplicationUserRole.xml 13, an ApplicationObjectPrivilege.xml 14, an AppUserRoleMapping.xml 15 and an AppRolePriorityRule.xml 16 (sometimes referred to in combination as “the relational XML set 11-16”). The Relational XML set 11-16 enables an entitlement web service that is controlled remotely as a single entry point for entitlement.

The ApplicationObjectTypeCode.xml 11 identifies and defines the generic type codes for each of the different types of objects for which access is controlled or otherwise determined by implementation of the relational XML set 11-16. Thus, a type code “T” is defined for relational database tables by the four XML lines 22. A type code “C” is defined for columns of the tables by the four XML lines 24. A type code “P” is defined for user interface (UI) pages of applications associated with the table by the four XML lines 26. A type code “F” is defined for a field of the user interface pages by the four XML lines 28. A type code “A” is defined for a menu of a sub application of the page applications by the four XML lines 30. The type codes can be defined for any user defined component, such as hyperlinks, field labels, etc.

The ApplicationObject.xml 12 assigns unique identification indicia and parent relationships to the names of the objects for which access will be controlled via implementation of the relational XML set 11-16. As will be appreciated by one skilled in the art, parent relationships are useful in identifying objects by their relationship to other known/defined objects), particularly with regard to multiple instances of a named object across multiple, different parent objects, such as “employee name” column objects that appear in each of a plurality of different organization tables with different table names. However it will be understood that parent relationship definitions are not necessary to define the security access for any given object defined and identified by the relational XML set 11-16. Thus, the set of seven lines 32 assigns the number “1” as a unique numeric object identification (“ObjID”) to table objects of the type “T” that have the name “EMP”, which is a name label assigned to tables of employee names having a complete object name “SCHEMA1.EMP”, and further wherein no other object is identified as a parent object of the EMP object (as no value is provided after “<ParentObjID>”). The set of seven lines 34 assigns the number “2” as a unique numeric object identification (“ObjID”) to the type “C” “EMP_ID” column objects of the named EMP table, which is a name label assigned to the columns of the table having the complete object name “SCHEMA1.EMP.EMP_ID.”; and wherein the EMP table is identified as the parent object of the EMP_ID column object as a function of the unique ID assigned to the EMP table by “<ParentObjID>1<ParentObjID>”.

The set of seven lines 36 assigns the number “3” as a unique numeric object identification (“ObjID”) to column objects (type “C”) of the specified object name (“EMP_NAME”) within the EMP table, as the EMP table is identified as the parent object of the EMP_NAME column object as a function of its unique by the line value “<ParentObjID>1<ParentObjID>”. The complete name of this table column object is also identified, as “SCHEMA1.EMP.EMP_NAME”. In a similar fashion, other lines (not shown) within the ApplicationObject.xml 12 assign unique identification indicia and parent relationships to the names of any other objects controlled by the relational XML set 11-16, for example objects of the type codes “P”, “F” and “A” defined above, as well as any other user-defined object.

The ApplicationUserRole.xml 13 contains all the roles which can be assigned to users to control application behavior. The set of five lines 42 assigns the number “1” as a unique numeric role identification (“RoleID”) to a system administration role (“RoleName”) within a certain, named “ABC” subgroup or subset (“OrgGroup”) within a greater organization population or universe, for example a department, work group, etc. The set of five lines 44 assigns the number “2” as a unique numeric role identification (“RoleID”) to a “VIEW:ALL” role or privilege (“RoleName”) to users within the “ABC” subgroup (“OrgGroup”). The set of five lines 46 assigns the number “3” as a unique numeric role identification (“RoleID”) to a “VIEW:USA” role or privilege (“RoleName”) to users within the “ABC” subgroup (“OrgGroup”). Lastly, the set of five lines 48 assigns the number “4” as a unique numeric role identification (“RoleID”) to an “EDIT:USA” role or privilege (“RoleName”) to users within a different “XYZ” subgroup (“OrgGroup”) of the users.

The ApplicationObjectPrivilege.xml 14 contains (defines) the security access or privileges to named objects and as a function of relationships between the named objects and the roles defined in the relational XML set 11-16. The set of eight lines 52 establishes the security or access to objects assigned the ObjID value of “1” (the table objects of the type “T” that have the name “EMP,” as defined by lines 32 of the ApplicationObject.xml 12) for users having the numeric RoleId value of “2” (the “VIEW:ALL” role defined by the lines 44 within the ApplicationUserRole.xml 13): namely, they can read data values from existing EMP table objects (“<Read>true</Read>”), but they cannot create new EMP table objects (“<Create>false</Create>”) or update or delete existing EMP table objects (“<Update>false</Update>,” and “<Delete>false</Delete>”). The set of eight lines 54 further establishes security to the child “EMP_ID” column objects of the parent EMP table object (having ObjID value of “3” as defined by lines 34 of the ApplicationObject.xml 12) for this same, VIEW:ALL user (RoleId value of “2”): again, they can read data values from the existing “EMP_ID” (ObjID 3) column objects (“<Read>true</Read>”), but they cannot create new objects (“<Create>false</Create>”) or update or delete existing objects (“<Update>false</Update>,” and “<Delete>false</Delete>”).

The set of eight lines 56 establishes the security or access to objects assigned the ObjID value of “1” (again, the EMP table objects) for users having the numeric RoleId value of “2” (the “System Administration” role defined by the lines 42 within the ApplicationUserRole.xml 13): namely they can read and update the data values in existing EMP table objects (“<Update>true</Update>” and “<Read>true</Read>”), but they cannot create new EMP table objects (“<Create>false</Create>”) or delete existing EMP table objects (“<Delete>false</Delete>”).

The set of eight lines 58 replaces the ObjID data value identifier at line 59 with a variable “like ‘ID %’”. Through implementing “dataValue” attributes services can be extended to control any set of data access (specific set of customer records of a database table). This attribute will have WHERE clause of the dataset. In execution the ApplicationObjectPrivilege.xml 14 thereby pulls the value for this element from a “where” clause in an associated field. This enables identification of an object type by a value as expected or retrieved by a database query routine if the “where” clause is found; otherwise, table values may be used to populate this value. Access to this query-returned object ID value for users having the “VIEW:ALL” (RoleId value of “2”) is thereby established, namely said VIEW:ALL users may read data values from existing objects (“<Read>true</Read>”), but they cannot create new objects (“<Create>false</Create>”) or update or delete existing objects (“<Update>false</Update>,” and “<Delete>false</Delete>”).

The ApplicationUserRoleMapping.xml 15 maps unique user identifications (ID's) to the defined roles. Thus, the set of four lines 62 maps RoleID “1” to a user having the unique identity indicia (“UserId”) of the email address “jjones@corp.com.” The set of four lines 64 maps RoleID “1” to another user having the unique indicia (“UserId”) of the email address “ssmith@corp.com.”

The AppRolePriorityRule.xml 16 gives an example of assigning relative priorities to the defined roles. In aspects of the present invention, a given user, and more particularly a given “UserId” unique identity indicia, may be mapped to multiple roles. If multiple roles are assigned to one user, and no rule is given priority over another, then access is granted to objects based on a union of each of the roles assigned to the user. For example, if a user has a “VIEW:ALL” role on country/nationality data in general, and is also assigned “VIEW:USA,” then the former role is applied as a function of the latter role, so that the user may not view all country object data for country object other than the USA, but is restricted to view USA-only data.

In an alternative to union of roles methodology, the AppRolePriorityRule.xml 16 gives an example of assigning relative priorities to the defined roles. Thus, the four lines 66 assign a “RolePriority” value of “1” to the “RoleID” having the value of “3.” Accordingly, RoleID=3 is assigned the highest priority, and its defined object permissions will control and override the permissions of any other roles (RoleID values) assigned to the user and having a lower priority value. The relative priority values control in a ranked, descending order. For example, if none of the roles assigned to a user have a priority value of “1”, then the role or roles of that user assigned a priority value of “2” will have the highest priority and control over other, lower-ranked roles assigned to the same user.

If more than one of the roles assigned to the user has the same, highest priority ranking or value for all roles assigned to that user, then a union of the highest-priority roles controls object access. For example, if a user has three roles with RolePriority=1, two roles with RolePriority=2 and ten roles without any RolePriority, then a union of the three RolePriority=1 roles will be applied. Further, if user roles do not have any priority entry defined by an applicable AppRolePriorityRule.xml 16, then union of the role's privileges will be applied.

Role priority and union operations may be dependent upon the object type or names. For example, if a UserID=X has a RolePriority=1 for a column object (ObjTypeCode=C) within a given table (ObjName=TableY), and also a RolePriority=2 for the parent table itself, then the permissions defined and associated with the roles having RolePriority=1 for this user applies to the column, and the permissions of the roles of the user having RolePrioriority=2 applies to the rest of the columns within the same table.

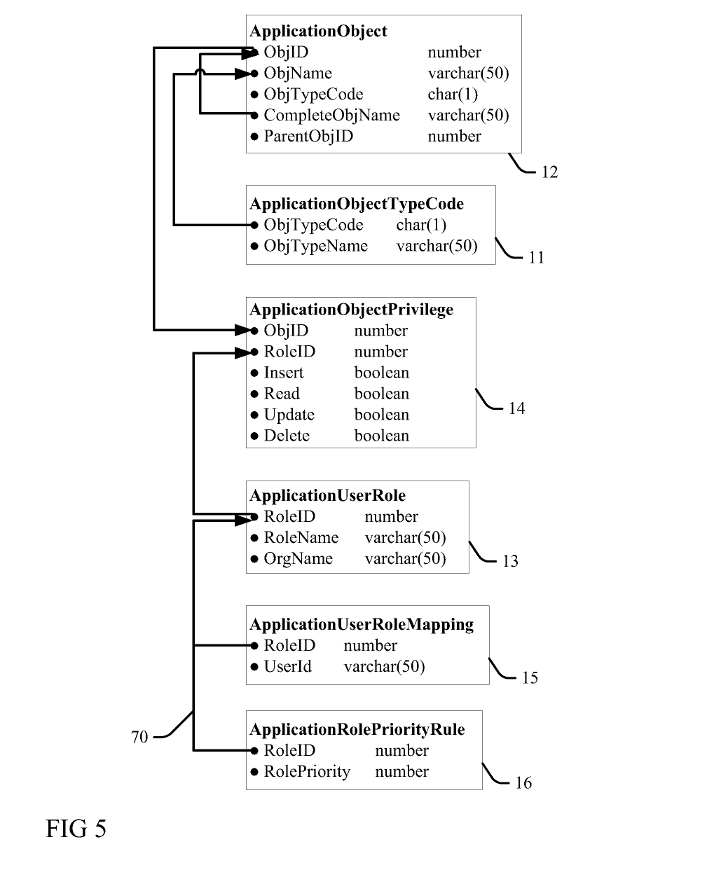

FIG. 5 provides an illustration of aspects of the relational database structure defined by referential links 70 signifying relationships of the components and attributes of the relational XML set 11-16. Thus, a unique object ID (ObjID) value (number) is related within the ApplicationObject.xml 12 to a complete name for the object (CompleteObjName) that is defined by as a Variable Character Field (“varchar”) set of character data of up to fifty alphanumeric characters (“varchar(50)”). This unique object ID (ObjID) also relates (links) the ApplicationObject.xml 12 to the ApplicationObjectPrivilege.xml 14, which defines the access privileges for the object based on roles, and wherein determining the appropriate roles is based on associated relational links 70 to the ApplicationObjectTypeCode.xml 11, the ApplicationUserRole.xml 13, the AppUserRoleMapping.xml 15 and the AppRolePriorityRule.xml 16. The XML links 70 thus define relationships between the XML to define application-independent object handling structures.

One centralized SSO interface may thereby use the relational XMLs 11-16 to define entitlement or authorization services for data objects that is universal and independent of the different formats and requirements of the various applications authorized by the SSO. Security access or privileges to named objects is a function of relationships between the named objects and the roles defined in the XML set 11-16, and is not dependent on any given external application used by the user to manipulate the data objects after access in granted by a SSO process. The object based approach according to the present invention provides for a reusable component that enables centralized access control for any system via an externally configurable utility. For example, for ten applications, if three should be controlled one way, the rest via another fashion, XML controls may be defined according to the present invention for the three, for calling services defined for the roles, etc., while the other seven applications are controlled via a different called service.

Services can be called inside or outside of a given application framework (for inside a given service provider framework, or via external frameworks), to provide any level of access on application objects, such as relational database tables, table attributes, application graphical user interface (GUI) pages and page objects including hyperlinks, text box, buttons, and also can control menu items. Services according to the present invention provide reusable component role mapping and role prioritization with system objects that is platform and programming language independent.

Different types of access to the objects are granted via a successful SSO entry based on different roles defined for different respective users, wherein the access is effected through a wide variety of different applications that share the SSO service and that may each have different types and levels (for example, small, medium, large or enterprise level). Rather than establishing differentiated access rights based on differences in access levels granted to individual users by the different respective systems as taught by the prior art, aspects provide differentiated user access to data objects via mapping users to different roles that have different accesses defined for the objects independent of application or system used by the users. Successful entry to an entitlement server via an SSO routine identifies a role defined for the user, and this identified role determines access to the data objects, independent of any rights or permissions the users may have within the system or application they are using for object access.

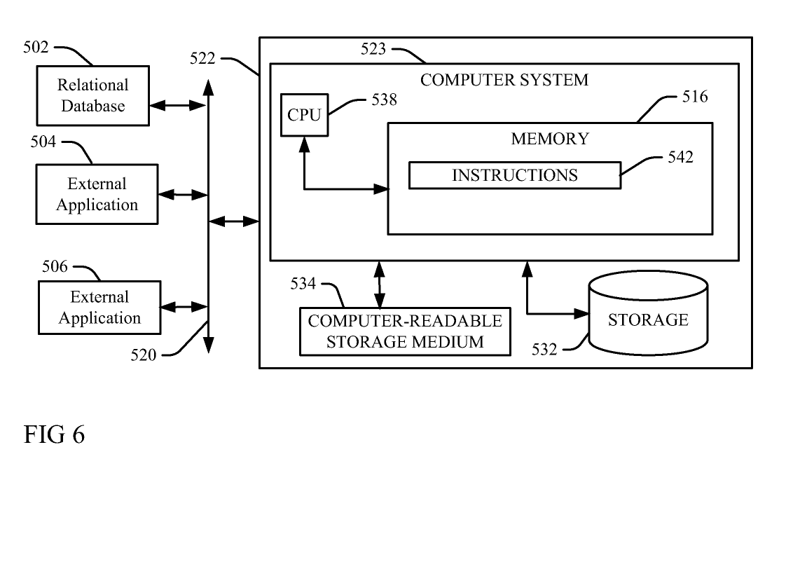

Referring now to FIG. 6, an exemplary computerized implementation of an aspect of the present invention includes a computer system or other programmable device 522 in communication 520 with a relational database 502, and with different external UI (or non-UI) applications 504 and 506. The programmable device 522 thus provides for a centralized single sign-on service for entitlement for multiple different applications to relational database objects as a function of a set of relational extensible mark-up language links, by determining role(s) that are mapped to the unique user identification by a first extensible mark-up language link in response to a secure, single sign-on validation of a unique user identification; determining a permission value that is within another extensible mark-up language link that is linked to the role(s) in the first extensible mark-up language link, wherein the permission value specifies a type of access to a unique data object identification; and determining an object type and an object name that are each within a third extensible mark-up language link and that are linked to the determined permission value and to the unique data object identification. The programmable device 522 thus enables different external applications that use different application formats to access a data object within a database pursuant to the determined permission value as a function of the data object having the unique data object identification.

Instructions 542 also reside within computer readable code in a computer readable memory 516, or in a computer readable storage system 532, or other tangible computer readable storage medium 534 that is accessed by a Central Processing Unit (processor or CPU) 538 of a computer system or infrastructure 523 of the programmable device 522. Thus, the instructions, when implemented by the processor 538, cause the processor 538 to provide for a centralized single sign-on service for entitlement for multiple different applications to relational database objects as a function of a set of relational extensible mark-up language links, by determining role(s) that are mapped to the unique user identification by a first extensible mark-up language link in response to a secure, single sign-on validation of a unique user identification; determining a permission value that is within another extensible mark-up language link that is linked to the role(s) in the first extensible mark-up language link, wherein the permission value specifies a type of access to a unique data object identification; and determining an object type and an object name that are each within a third extensible mark-up language link and that are linked to the determined permission value and to the unique data object identification.

In one aspect, the present invention may also perform process steps of the invention on a subscription, advertising, and/or fee basis. That is, a service provider could offer to integrate computer-readable program code into the computer system 522 to enable the computer system 522 to provide for a centralized single sign-on service for entitlement for multiple different applications to relational database objects as a function of a set of relational extensible mark-up language links, by determining role(s) that are mapped to the unique user identification by a first extensible mark-up language link in response to a secure, single sign-on validation of a unique user identification; determining a permission value that is within another extensible mark-up language link that is linked to the role(s) in the first extensible mark-up language link, wherein the permission value specifies a type of access to a unique data object identification; and determining an object type and an object name that are each within a third extensible mark-up language link and that are linked to the determined permission value and to the unique data object identification. The service provider can create, maintain, and support, etc., a computer infrastructure, such as the computer system 522, network environment 520, or parts thereof, that perform the process steps of the invention for one or more customers. In return, the service provider can receive payment from the customer(s) under a subscription and/or fee agreement and/or the service provider can receive payment from the sale of advertising content to one or more third parties. Services may include one or more of: (1) installing program code on a computing device, such as the computer device 522, from a tangible computer-readable medium device 532 or 534; (2) adding one or more computing devices to a computer infrastructure; and (3) incorporating and/or modifying one or more existing systems of the computer infrastructure to enable the computer infrastructure to perform the process steps of the invention.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The aspect was chosen and described in order to best explain the principles of the invention and the practical application, and to enable others of ordinary skill in the art to understand the invention for various embodiments with various modifications as are suited to the particular use contemplated.

The flowchart and block diagrams in the figures illustrate the architecture, functionality, and operation of possible implementations of systems, methods and computer program products according to various aspects of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for a centralized single sign-on service for entitlement for multiple different application interface objects to relational database objects as a function of a set of relational extensible mark-up language links, the method comprising:
in response to a secure, single sign-on validation of a unique user identification, determining at least one role that is mapped to the unique user identification by a first extensible mark-up language link;
determining a permission value that is within a second extensible mark-up language link and that is linked to the at least one role in the first extensible mark-up language link, wherein the permission value specifies a type of access to a unique data object identification;
determining an object type and an object name that are each within a third extensible mark-up language link and that are linked to the determined permission value and to the unique data object identification; and
enabling first and second external applications to access a data object within a database pursuant to the determined permission value as a function of the data object having the unique data object identification, wherein the first and the second external applications use different application formats.

2. The method of claim 1, further comprising:
integrating computer-readable program code into a computer system comprising a processor, a computer readable memory and a computer readable storage medium, wherein the computer readable program code is embodied on the computer readable storage medium and comprises instructions that, when executed by the processor via the computer readable memory, cause the processor to perform the steps of determining the at least one role that is mapped to the unique user identification by the first extensible mark-up language link in response to the secure, single sign-on validation of the unique user identification, determining the permission value that is within the second extensible mark-up language link and that is linked to the at least one role in the first extensible mark-up language link, determining the object type and the object name that are each within the third extensible mark-up language link and that are linked to the determined permission value and to the unique data object identification, and enabling the first and the second external applications to access the data object within the database pursuant to the determined permission value as the function of the data object having the unique data object identification.

3. The method of claim 1, wherein the step of enabling the first and the second external applications to access the data object within the database pursuant to the determined permission value as the function of the data object having the unique data object identification comprises:
indicating a true value for a type of access to the data object that is permitted by the determined permission value; and
indicating a false value for a type of access to the data object that is forbidden by the determined permission value.

4. The method of claim 3, wherein the at least one role is a plurality of roles, the method further comprising:
determining a highest priority set of the plurality of roles; and
generating a union of the highest priority set of the plurality of roles to resolve a conflict of interest between permissions of the highest priority set of the plurality of roles; and
wherein the permission value determined within the second extensible mark-up language link is linked to the union of the highest priority set of the plurality of roles.

5. The method of claim 3, wherein the type of access to the data object that is permitted or forbidden by the determined permission value is a read, write, create or delete access.

6. The method of claim 3, further comprising:
populating a value within one of the first, second and third extensible mark-up language links for unique data object identification with a variable data value attribute; and
determining a value of the variable data value attribute via a where clause routine.

7. The method of claim 3, further comprising:
differentiating the at least one role from another role as function of a user subgroup that is mapped to the unique user identification by the first extensible mark-up language link.

8. The method of claim 7, further comprising:
checking a combination of the determined at least one role that is mapped to the unique user identification and the user subgroup that is mapped to the unique user identification against a master list for the first, second and third extensible mark-up language links; and
returning an error message and preventing the first and second external applications from accessing the data object within the database in response to not finding the combination in the master list.

9. A system, comprising:
a processor;
a computer readable memory in circuit communication with the processor; and
a computer readable storage medium in circuit communication with the processor;
wherein the processor, when executing program instructions stored on the computer-readable storage medium via the computer readable memory:
determines at least one role that is mapped to the unique user identification by a first extensible mark-up language link in response to a secure, single sign-on validation of a unique user identification;
determines a permission value that is within a second extensible mark-up language link and that is linked to the at least one role in the first extensible mark-up language link, wherein the permission value specifies a type of access to a unique data object identification;
determines an object type and an object name that are each within a third extensible mark-up language link and that are linked to the determined permission value and to the unique data object identification; and
enables first and second external applications to access a data object within a database pursuant to the determined permission value as a function of the data object having the unique data object identification, wherein the first and the second external applications use different application formats.

10. The system of claim 9, wherein the processor, when executing the program instructions stored on the computer-readable storage medium via the computer readable memory, enables the first and the second external applications to access the data object within the database pursuant to the determined permission value as the function of the data object having the unique data object identification by:
indicating a true value for a type of access to the data object that is permitted by the determined permission value; and
indicating a false value for a type of access to the data object that is forbidden by the determined permission value.

11. The system of claim 10, wherein the processor, when executing the program instructions stored on the computer-readable storage medium via the computer readable memory, further:
determines a highest priority set of the plurality of roles;
generates a union of the highest priority set of the plurality of roles to resolve a conflict of interest between permissions of the highest priority set of the plurality of roles; and
determines the permission value within the second extensible mark-up language link as a value linked to the union of the highest priority set of the plurality of roles.

12. The system of claim 10, wherein the type of access to the data object that is permitted or forbidden by the determined permission value is a read, write, create or delete access.

13. The system of claim 10, wherein the processor, when executing the program instructions stored on the computer-readable storage medium via the computer readable memory, further:
populates a value within one of the first, second and third extensible mark-up language links for unique data object identification with a variable data value attribute; and
determines a value of the variable data value attribute via a where clause routine.

14. The system of claim 10, wherein the processor, when executing the program instructions stored on the computer-readable storage medium via the computer readable memory, further:
differentiates the at least one role from another role as function of a user subgroup that is mapped to the unique user identification by the first extensible mark-up language link;
checks a combination of the determined at least one role that is mapped to the unique user identification and the user subgroup that is mapped to the unique user identification against a master list for the first, second and third extensible mark-up language links; and
returns an error message and prevents the first and second external applications from accessing the data object within the database in response to not finding the combination in the master list.

15. A computer program product for a centralized single sign-on service for entitlement for multiple different application interface objects to relational database objects as a function of a set of relational extensible mark-up language links, the computer program product comprising:
a computer readable storage medium having computer readable program code embodied therewith, the computer readable program code comprising instructions that, when executed by a processor, cause the processor to:
determine at least one role that is mapped to the unique user identification by a first extensible mark-up language link in response to a secure, single sign-on validation of a unique user identification;
determine a permission value that is within a second extensible mark-up language link and that is linked to the at least one role in the first extensible mark-up language link, wherein the permission value specifies a type of access to a unique data object identification;
determine an object type and an object name that are each within a third extensible mark-up language link and that are linked to the determined permission value and to the unique data object identification; and
enable first and second external applications to access a data object within a database pursuant to the determined permission value as a function of the data object having the unique data object identification, wherein the first and the second external applications use different application formats.

16. The computer program product of claim 15, wherein the computer readable program code instructions, when executed by the processor, further cause the processor to enable the first and the second external applications to access the data object within the database pursuant to the determined permission value as the function of the data object having the unique data object identification by:
indicating a true value for a type of access to the data object that is permitted by the determined permission value; and
indicating a false value for a type of access to the data object that is forbidden by the determined permission value.

17. The computer program product of claim 16, wherein the computer readable program code instructions, when executed by the processor, further cause the processor to:
determine a highest priority set of the plurality of roles;
generate a union of the highest priority set of the plurality of roles to resolve a conflict of interest between permissions of the highest priority set of the plurality of roles; and
determine the permission value within the second extensible mark-up language link as a value linked to the union of the highest priority set of the plurality of roles.

18. The computer program product of claim 16, wherein the type of access to the data object that is permitted or forbidden by the determined permission value is a read, write, create or delete access.

19. The computer program product of claim 16, wherein the computer readable program code instructions, when executed by the processor, further cause the processor to:
populate a value within one of the first, second and third extensible mark-up language links for unique data object identification with a variable data value attribute; and
determine a value of the variable data value attribute via a where clause routine.

20. The computer program product of claim 16, wherein the computer readable program code instructions, when executed by the processor, further cause the processor to:
differentiate the at least one role from another role as function of a user subgroup that is mapped to the unique user identification by the first extensible mark-up language link;
check a combination of the determined at least one role that is mapped to the unique user identification and the user subgroup that is mapped to the unique user identification against a master list for the first, second and third extensible mark-up language links; and
return an error message and prevents the first and second external applications from accessing the data object within the database in response to not finding the combination in the master list.
